(19) United States
(12) Patent Application Publication
(10) Pub. No.: US 2014/0005816 A1
(43) Pub. Date: Jan. 2, 2014

(54) Design Support System

(71) Applicant: Hitachi, Ltd., Tokyo (JP)

(72) Inventors: Norihiko NONAKA, Tsuchiura-shi (JP); Ichiro NISHIGAKI, Ishioka-shi (JP)

(21) Appl. No.: 13/928,188

(22) Filed: Jun. 26, 2013

(30) Foreign Application Priority Data
Jun. 27, 2012 (JP) 2012-143676

(51) Int. Cl. G05B 15/02

(52) U.S. Cl. CPC G05B 15/02
USPC 700/97

(57) ABSTRACT

There is a need to provide a design support system and a method thereof that extract common parts in consideration of relation to the performance. An apparatus and a method acquire common parts using multi-objective optimization. Specifically, a design support system using common parts and a method thereof include the following means. One means enters information about a shape model, an analysis condition, and an optimization condition. Another means uses multi-objective genetic algorithm to perform optimization. Still another means groups a Pareto solution as an acquired optimization result, analyzes dispersion of design variables, and associates them with a shape model. Yet another means displays common parts.

### CLAIM OF PRIORITY

The present application claims priority from Japanese application serial no. 2012-143676, filed on Jun. 27, 2012, the content of which is hereby incorporated by reference into this application.

### FIELD OF THE INVENTION

The present invention relates to a design support system. More particularly, the invention relates to a computer-based design support technology that extracts common parts for a product by performing multi-objective optimization on the product performance and costs.

### BACKGROUND OF THE INVENTION

Conventionally, a design support technology extracts common parts from parts configured as machine structures and includes a method of providing common model data according to expressivity levels of shape models. Japanese Unexamined Patent Publication No. 2006-338557 (patent document 1) describes the background technology of the design support technology. The publication describes the design drawing management system that provides common data for the same model and enables the use of CAD data for parts of the same shape model according to applications. The system includes two storage means and an output means. One storage means generates CAD data for models with different expressivity levels for models with the same shape and cumulatively stores the CAD data in a file. The other storage means stores the following information. One piece of information indicates relation among a model designer, CAD data for the model, and the model. Another piece of information indicates states of a file that contains an expressivity level of the model. Purpose information contains model expressivity levels according to utilization purposes. The output means outputs CAD data for models with different expressivity levels to a client terminal according to the purpose information.

The shape optimization technology using numerical simulation provides an optimization method. The method finds a relational expression between a design variable such as a machine structure dimension and an objective function such as a pressure loss coefficient found by the numerical simulation. The method uses this relational expression to find a design variable that minimizes the objective function. Japanese Unexamined Patent Publication No. 2004-110470 (patent document 2) describes the background technology of the shape optimization technology. The publication describes the optimum design computation device that computes a combination of explanatory variable values having optimal objective variable values. The computation device includes an explanatory variable computation portion, a response surface computation portion, and an objective variable optimization portion. The explanatory variable computation portion uses a space-filling curve to compute a combination of explanatory variable values that are distributed as evenly as possible. The response surface computation portion is supplied with an analysis program for computing objective variable values and with an explanatory variable value in terms of a specified explanatory variable value. The response surface computation portion uses the analysis program to compute an objective variable value. The response surface computation portion is supplied with an explanatory variable and an objective variable value to compute a response surface that represents relationship between the explanatory variable value and the objective variable value. The objective variable optimization portion is supplied with a response surface to optimize objective variable values.

Conventional design support technologies to extract common parts use a model expressivity level as an index to extract common parts. Common parts are extracted based on model similarities. On the other hand, efficiency or costs may be used as indexes that represent the performance of a machine structure. For example, the shape of the machine structure may be changed to satisfy the targeted performance. The performance is not considered if common parts are extracted based on model similarities and are used accordingly. The targeted performance may not be satisfied.

The technology described in patent document 1 is insufficient to extract common parts in consideration of relation to the performance.

While changing design variables such as dimensions, the conventional optimization technology performs numerical simulation to compute a dimension value that provides the maximum objective function for the computed efficiency. All dimensions as design variables may be changed. It is difficult to extract a common part indicative of a part whose dimension need not be changed.

The technology described in patent document 2 is insufficient to extract common parts.

It is an object of the invention to provide a design support system and a method thereof that extract common parts in consideration of relation to the performance.

### SUMMARY OF THE INVENTION

The configurations described in the appended claims are used to solve the above-mentioned problems.

The application concerned includes multiple means to solve the above-mentioned problems. For example, there is provided a design support system to acquire common parts. The design support system includes the following portions. An input portion accepts information about a shape model to extract common parts, an analysis condition, and an optimization condition. An optimization portion references the information and performs multi-objective optimization. An evaluation portion groups a Pareto solution as an acquired optimization result, analyzes dispersion of design variables, associates design variables with a shape model, and extracts specifically associated parts as common parts. A display portion displays extracted common parts.

There is provided a design support method to acquire common parts. The method accepts information about a shape model to extract common parts, an analysis condition, and an optimization condition from a user terminal. The method references the information and performs multi-objective optimization. The method groups a Pareto solution as an acquired optimization result. The method analyzes dispersion of design variables. The method associates design variables with a shape model. The method extracts specifically associated parts as common parts. The method displays the common parts on the user terminal.

The invention can provide a design support system and a method thereof that extract common parts in consideration of relation to the performance. It is possible to distinguish parts that need not be changed when the specification is changed. The use of common parts can reduce costs.

The foregoing and other advantages and features of the invention will become more apparent from the detailed description of the preferred embodiments of the invention given below with reference to the accompanying drawings.

### BRIEF DESCRIPTION OF THE DRAWINGS

FIG. 1 is an overall configuration diagram illustrating an embodiment of the invention;

FIG. 2 illustrates a process (phase 1) according to the embodiment of the invention;

FIG. 3 illustrates a process (phase 2) according to the embodiment of the invention;

FIG. 4 illustrates a process (phase 3) according to the embodiment of the invention;

FIG. 5 illustrates the process (phase 3) continued from FIG. 4 according to the embodiment of the invention;

FIG. 6 illustrates machine structure A according to the embodiment of the invention;

FIG. 7 illustrates machine structure B according to the embodiment of the invention;

FIG. 8 illustrates a shape model input screen (plant A) according to the embodiment of the invention;

FIG. 9 illustrates a shape model input screen (plant B) according to the embodiment of the invention;

FIG. 10 illustrates an analysis condition input screen (plant A) according to the embodiment of the invention;

FIG. 11 illustrates an analysis condition input screen (plant B) according to the embodiment of the invention;

FIG. 12 illustrates an optimization condition input screen (plant A) according to the embodiment of the invention;

FIG. 13 illustrates an optimization condition input screen (plant B) according to the embodiment of the invention;

FIG. 14 illustrates an optimization result (Pareto solution) according to the embodiment of the invention;

FIG. 15 illustrates a common parts display screen according to the embodiment of the invention; and

FIG. 16 illustrates the common parts display screen continued from FIG. 15 according to the embodiment of the invention.

### DETAILED DESCRIPTION OF THE PREFERRED EMBODIMENTS

An embodiment of the invention describes a design support system using common parts and a method of the same including the following means. One means displays a shape model input screen and allows an operator to enter a shape model and a shape model parts list, acquire input information, and supply the information to a database. The shape model corresponds to an assembly from which common parts are extracted. Another means displays an analysis condition input screen and allows an operator to enter a shape model to be analyzed, a boundary condition, an entry boundary condition, and an exit boundary condition, acquire input information, and supply the information to a database. Still another means displays an optimization condition input screen. The means allows an operator to provide a shape model input from the analysis condition input screen with a design variable, its lower limit, initial value, upper limit, and objective function for optimization, the number of populations, the number of generations, and a convergence test condition for genetic algorithm, and the number of CPUs for parallel computation. The means also allows the operator to acquire input information and supply the information to a database. Yet another means acquires information input to the shape model input screen from the database and generates as many analysis models as the number of populations according to the design variable value determined by the optimization means. The means generates a mesh for the analysis model and supplies an analysis condition to the analysis model. The means runs multiple CPUs in parallel to perform fluid analysis on as many analysis models as the number of populations and compute an analysis model weight. Still yet another means performs genetic algorithm to compute a next-generation design variable using crossover and mutation based on the analysis result computed by the previous means so as to minimize the objective function. The means performs multi-objective optimization and supplies an acquired optimization result to a database. Yet still another means acquires the optimization result acquired by the optimization means from the database and displays a Pareto solution as an optimum solution for an operator. Still yet another means acquires the optimization result and the shaped model information from the database and displays a common parts display screen. The means groups the Pareto solution as an optimization result into the number of groups specified by the operator in consideration of the objective function. The means computes the dispersion of design variables for the group specified by the operator and extracts parts associated with design variables below a threshold value specified by the operator. Yet still another means displays the common parts extracted by the previous means on the common parts display screen and supplies the common parts to the database.

Extracting common parts for machine structures eliminates the need for unnecessary design changes due to specification changes. The use of common parts can reduce costs.

Multi-objective optimization is performed on an assembly as a machine structure to minimize an operator-specified objective function. A Pareto solution as an acquired optimization result is grouped. Dispersion of design variables for the groups is computed to extract parts of an assembly corresponding to the design variable as common parts. This can distinguish parts that need not be changed when the specification is changed. The use of common parts can reduce costs. Embodiments of the present invention will be described with reference to the accompanying drawings.

### First Embodiment

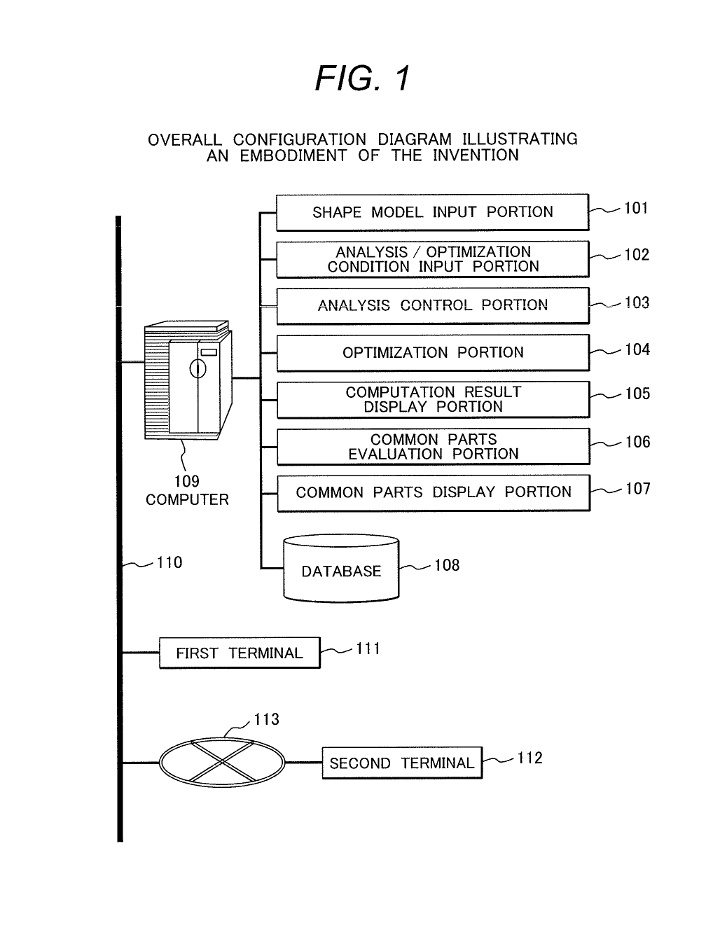

FIG. 1 illustrates a schematic configuration of the design support system using common parts according to an embodiment of the invention. As illustrated in FIG. 1, the system according to the embodiment includes a shape model input portion 101, an analysis/optimization condition input portion 102, an analysis control portion 103, an optimization portion 104, a computation result display portion 105, a common parts evaluation portion 106, a common parts display portion 107, a database 108, and a computer 109. This configuration can provide the design support system. An extended design support system may include a network 110 such as LAN connected from the computer 109 and a first terminal 111 available to users, for example. Further, the design support system may include a second terminal 112 available to users via a wide-area network 113 such as the Internet connected to the network 110 such as LAN, for example. Obviously, there may be more than one first terminal 111 or second terminal 112.

The shape model input portion 101 displays the shape model input screen. The operator enters a shape model and a parts list for the shape model. The shape model is an assembly from which common parts are to be extracted. The operator acquires input information and supplies it to the database 108.

The analysis/optimization condition input portion 102 displays the analysis condition input screen. The operator enters a shape model to be analyzed, a boundary condition, an entry boundary condition, or an exit boundary condition. The operator acquires input information and supplies it to the database 108. The analysis/optimization condition input portion 102 also displays the optimization condition input screen. The operator provides the following information for the shape model input to the analysis condition input screen. The information for the optimization includes a design variable, its lower limit, initial value, upper limit, and objective function. The information for the genetic algorithm includes the number of populations, the number of generations, and a convergence test condition. The information for the parallel computation includes the number of CPUs. The operator acquires input information and supplies it to the database 108.

The analysis control portion 103 acquires the information input to the shape model input portion 101 from the database 108. The analysis control portion 103 generates as many analysis models as the number of populations according to the design variable value. The analysis control portion 103 generates meshes and provides analysis conditions for analysis models. The analysis control portion 103 allows multiple CPUs in parallel to perform fluid analysis on as many analysis models as the number of populations. The analysis control portion 103 further computes an analysis model weight.

The optimization portion 104 performs genetic algorithm to compute a next-generation design variable using crossover and mutation based on the analysis result computed by the analysis control portion 103 so as to minimize the objective function. The optimization portion 104 performs multi-objective optimization and supplies an acquired optimization result to the database 108.

The computation result display portion 105 acquires the optimization result acquired by the optimization portion 104 from the database 108 and displays a Pareto solution as an optimum solution for the operator.

The common parts evaluation portion 106 acquires the optimization result and the shaped model information from the database 108 and displays the common parts display screen. The common parts evaluation portion 106 groups the Pareto solution as an optimization result into the number of groups specified by the operator in consideration of the objective function. The common parts evaluation portion 106 computes the dispersion of design variables for the group specified by the operator and extracts parts associated with design variables below a threshold value specified by the operator.

The common parts display portion 107 displays the common parts extracted by the common parts evaluation portion 106 on the common parts display screen and supplies the common parts to the database 108.

The database 108 stores the information acquired by the shape model input portion 101, the analysis/optimization condition input portion 102, the analysis control portion 103, the optimization portion 104, the computation result display portion 105, and the common parts evaluation portion 106.

The computer 109 includes an arithmetic logical unit and an input and output device such as a keyboard, a mouse, or a display. The input and output device displays an operator-input screen on the display. The input and output device acquires information from the keyboard and the mouse and displays processing results on the display. The arithmetic logical unit performs processes ranging from the shape model input portion 101 to the database 108 included in the system.

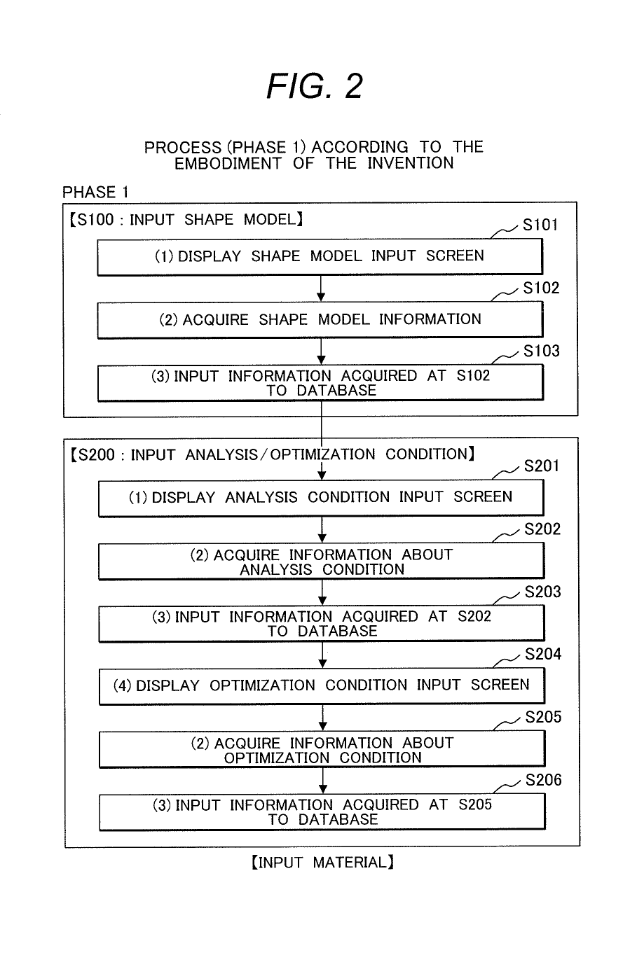

The following describes processes of the embodiment according to the above-mentioned configuration with reference to FIGS. 2 through 5. FIGS. 2, 3, 4, and 5 are flowcharts showing processes in the design support system using common parts as illustrated in FIG. 1. The processes of the embodiment are generally classified into three phases 1 through 3. Phase 1 inputs a shape model to find common parts, an analysis model condition, and an optimization condition. Phase 2 performs fluid analysis according to the information input at phase 1, performs optimization, and displays an optimization result. Phase 3 classifies the optimization result from phase 2 into groups characteristic of the optimum solution, analyzes the group state to extract common parts, and displays the common parts.

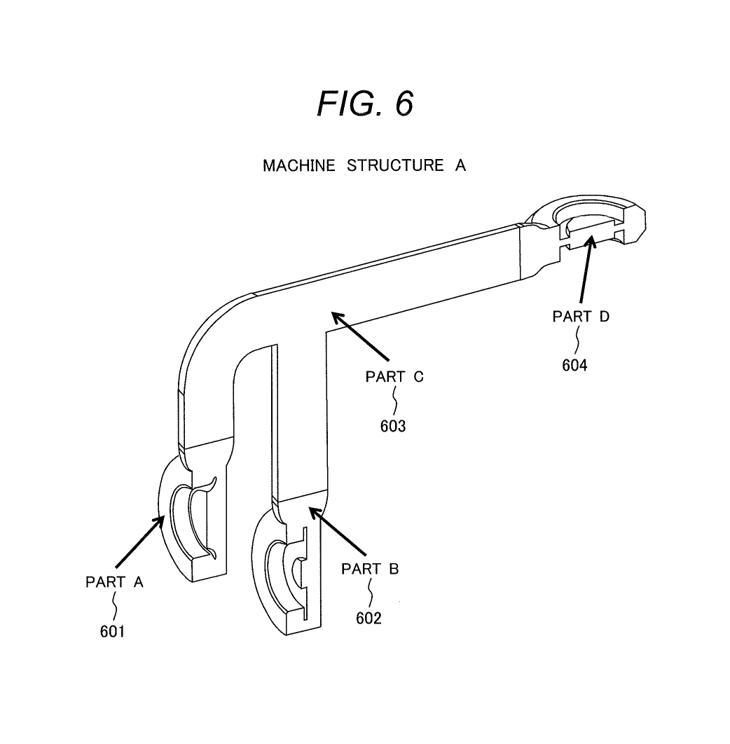

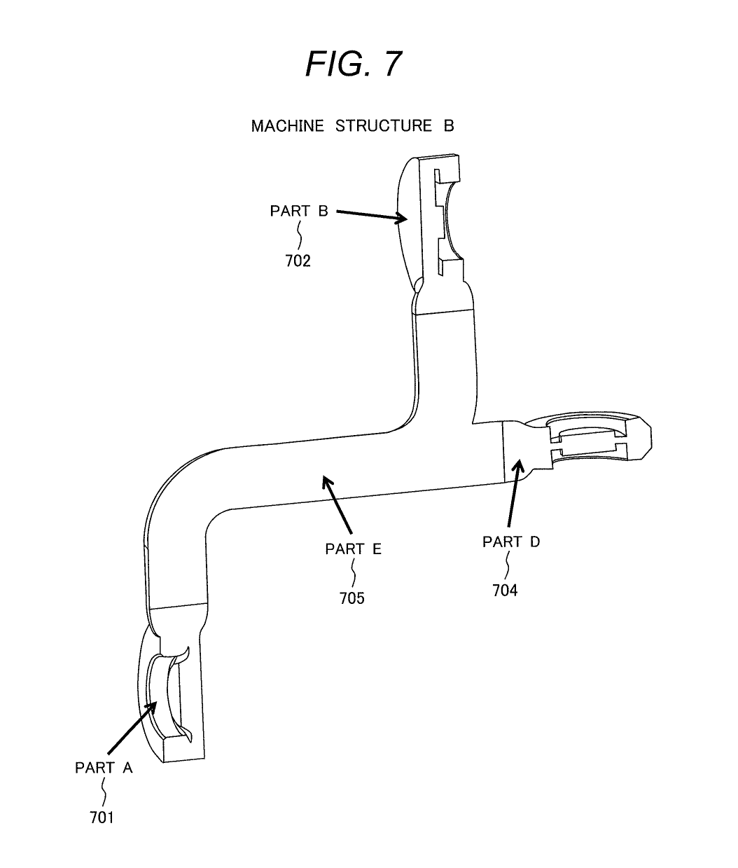

The following describes a method of extracting common parts from machine structures A and B starting from phase 1 with reference to machine structures A and B illustrated in FIGS. 6 and 7. Machine structure A is an assembly of four parts A601, B602, C603, and D604. Machine structure B is an assembly of four parts A701, B702, D704, and E705. Parts A601 and A701, parts B602 and B702, and parts D604 and D704 are equal to each other. Fluid flows inside machine structures A and B. Fluid enters part A and exists from parts B and D.

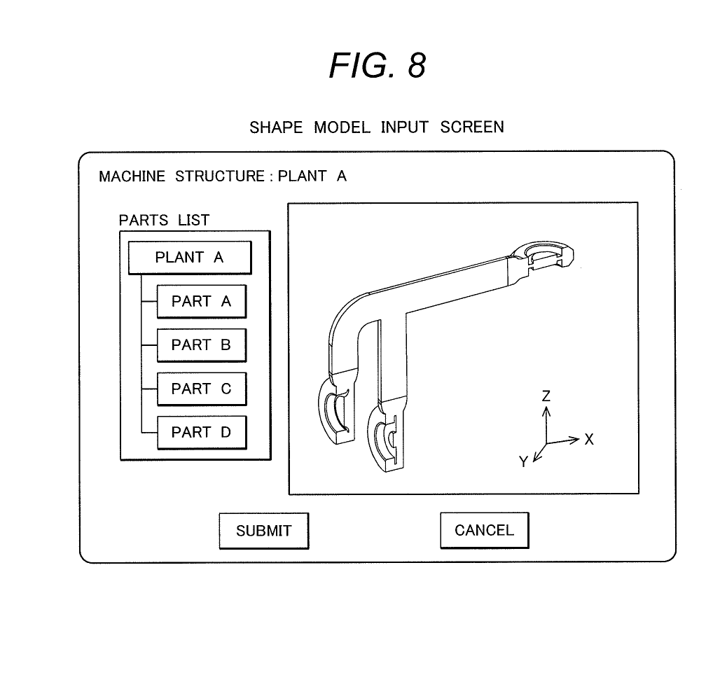

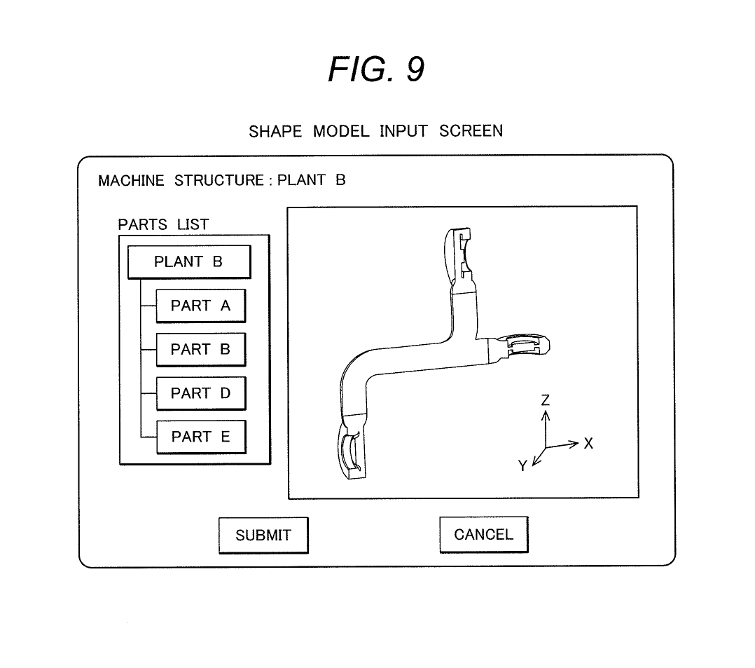

At S100 of phase 1 illustrated in FIG. 2, the shape model input portion 101 inputs a shape model. The analysis/optimization condition input portion 102 inputs an analysis model condition and an optimization condition. At S101, the shape model input portion 101 outputs a shape model input screen. FIG. 8 illustrates a shape model input screen. Using the screen, a designer enters a shape model from which common parts are extracted. In this example, machine structure A is entered. Plant A is entered as a machine structure name to enter machine structure A. Parts structure information is also entered. A parts list shows parts A, B, C, and D included in the assembly. Multiple machine structures need to be entered to extract common parts between machine structures. The shape model input portion 101 outputs a shape model input screen. FIG. 9 illustrates a shape model input screen. Similarly to FIG. 8, machine structure B is entered as plant B. The parts list shows a shape model and parts structure information corresponding to the assembly.

At S102, the shape model input portion 101 acquires the shape model and the parts structure information entered at S101. According to the embodiment, the shape model input portion 101 acquires information about machine structures A and B.

At S103, the shape model input portion 101 supplies the database 108 with the information acquired at S102.

At S200 in FIG. 2, the analysis/optimization condition input portion 102 supplies an analysis condition and an optimization condition to the shape model entered at S100.

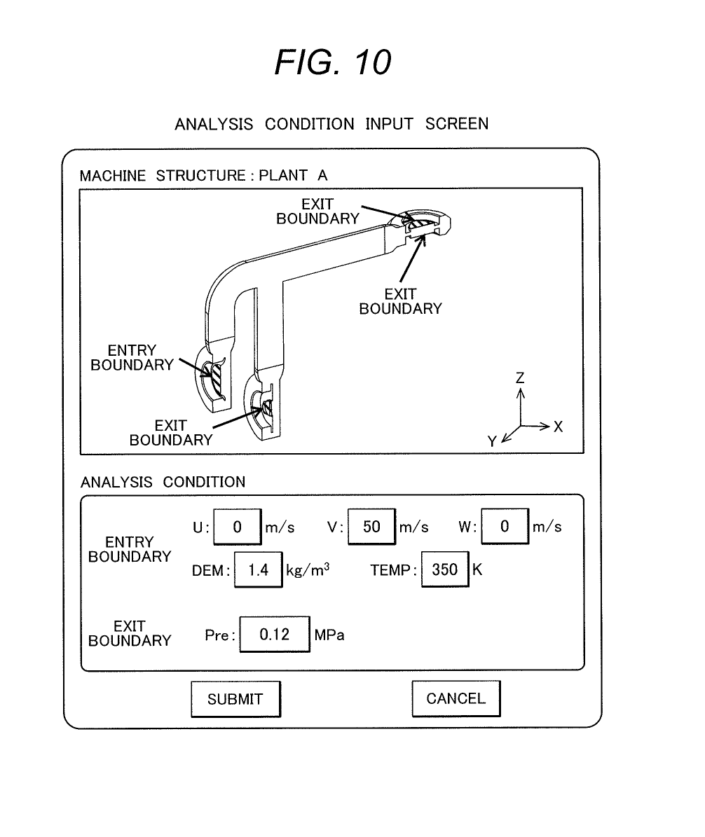

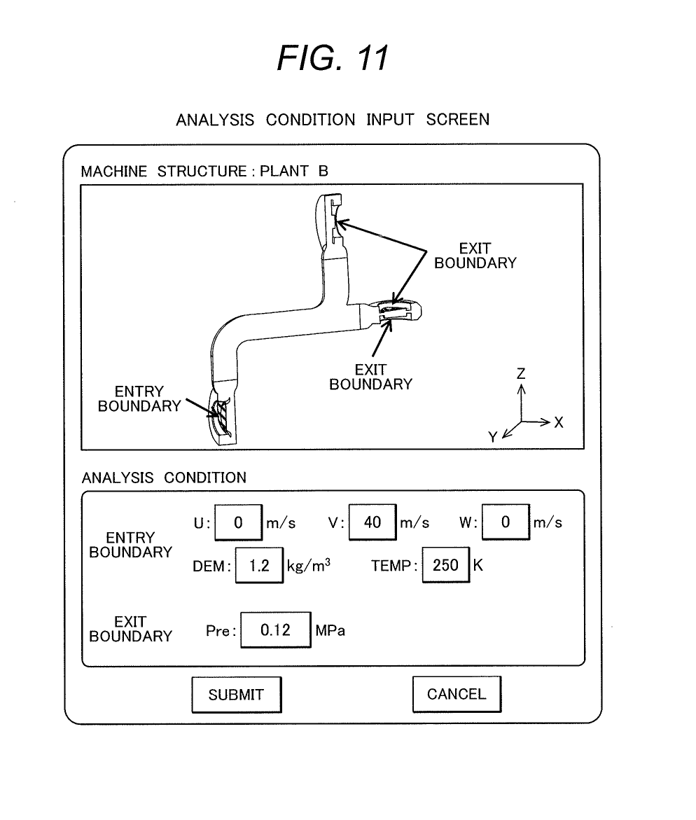

At S201, the analysis/optimization condition input portion 102 displays an analysis condition input screen. FIG. 10 illustrates an analysis condition input screen. Plant A as a machine structure is entered. In FIG. 10, a shape model for plant A is entered. An entry boundary and an exit boundary are entered because the fluid analysis is performed. As analysis conditions, the entry boundary is supplied with 0 m/s as X-direction flow rate U, 50 m/s as Y-direction flow rate V, 0 m/s as Z-direction flow rate W, 1.4 kg/m³ as density DEN, and 350 K as temperature TEMP. The exit boundary is supplied with 0.12 MPa. Plant B as a machine structure is also entered. FIG. 11 illustrates an analysis condition input screen. In FIG. 11, a shape model for plant B is entered. An entry boundary and an exit boundary are also entered. As analysis conditions, the entry boundary is supplied with 0 m/s as X-direction flow rate U, 40 m/s as Y-direction flow rate V, 0 m/s as Z-direction flow rate W, 1.2 kg/m³ as density DEN, and 250 K as temperature TEMP. The exit boundary is supplied with 0.12 MPa.

At S202, the analysis/optimization condition input portion 102 acquires the analysis conditions entered at S201. According to the embodiment, the analysis/optimization condition input portion 102 acquires information about machine structures A and B.

At S203, the analysis/optimization condition input portion 102 supplies the database 108 with the information acquired at S202.

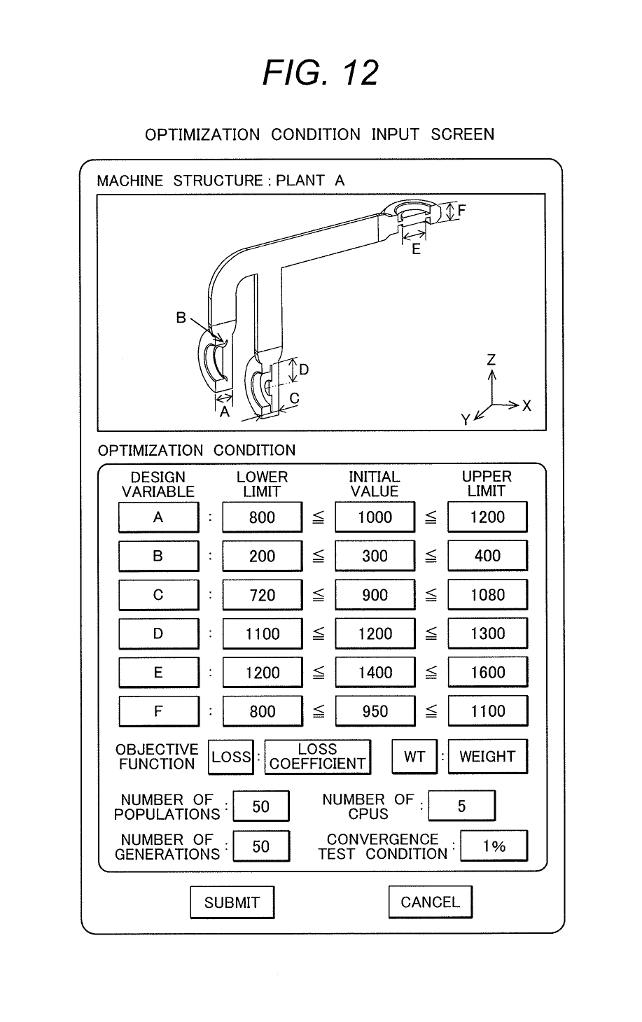

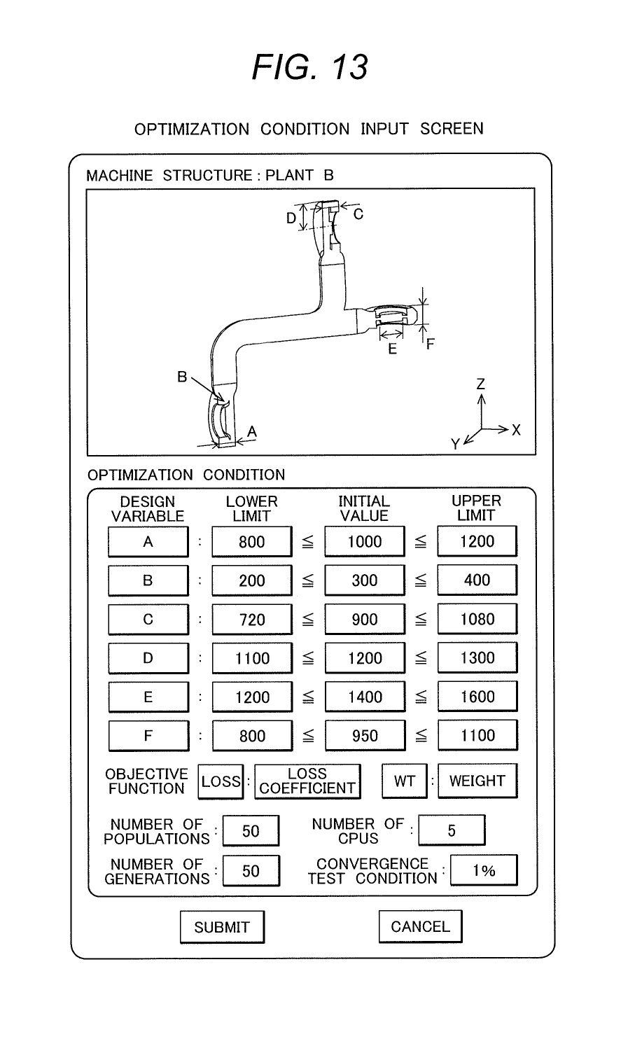

At S204, the analysis/optimization condition input portion 102 displays an optimization condition input screen. FIG. 12 illustrates an optimization condition input screen. Plant A is entered. In FIG. 12, a shape model for plant A is entered. As design variables, part A is supplied with dimensions A and B. Part B is supplied with dimensions C and D. Part D is supplied with dimensions E and F. As optimization conditions, design variable A is supplied with lower limit 800, initial value 1000, and upper limit 1200. Similarly, design variables B through F are supplied with lower limits, initial values, and upper limits. The objective function is supplied with loss coefficient LOSS and weight WT. LOSS and WT are variable names for the optimization. The weight directly links with material costs and is therefore synonymous with the material cost reduction. For this reason, the weight is selected as the objective function. The genetic algorithm is used as a multi-objective optimization algorithm. The supplied genetic algorithm parameters include number of populations 50, number of generations 50, and convergence test condition 1%. The fluid analysis corresponding to the number of populations uses multiple CPUs to perform parallel computation. The number of CPUs 5 is also entered. Plant B as a machine structure is also entered. FIG. 13 illustrates an optimization condition input screen for plant B. In FIG. 13, a shape model for plant B is entered. As design variables, part A is supplied with dimensions A and B. Part B is supplied with dimensions C and D. Part D is supplied with dimensions E and F. The design variables are similarly supplied with lower limits, initial values, and upper limits as optimization conditions. The objective function is supplied with loss coefficient LOSS and weight WT. Parameters entered for the multi-objective optimization algorithm include the number of populations, the number of generations, the convergence test condition, and the number of CPUs for parallel computation.

At S205, the analysis/optimization condition input portion 102 acquires the optimization information entered at S204. According to the embodiment, the analysis/optimization condition input portion 102 acquires the information about plants A and B.

At S206, the analysis/optimization condition input portion 102 supplies the information acquired at S205 to the database 108.

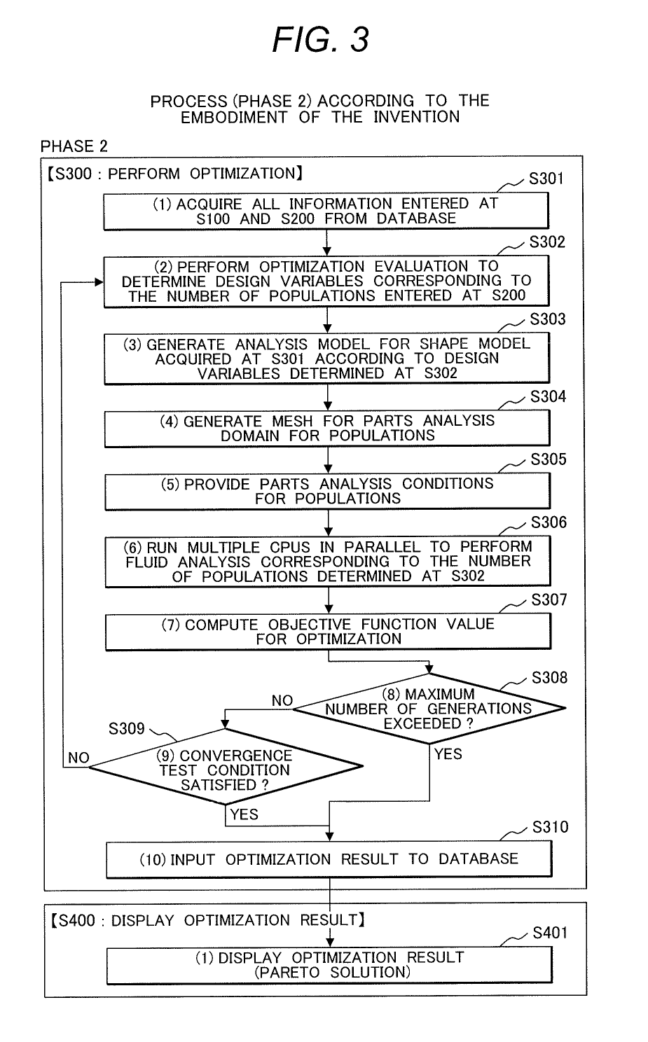

Phase 2 will be described with reference to FIG. 3. At S300 in FIG. 3, the analysis control portion 103 performs fluid analysis and computes weights. The optimization portion 104 performs optimization based on the computation result acquired by the analysis control portion 103. The computation result display portion 105 displays an optimization result acquired by the optimization portion 104.

At S301, phase 2 acquires information about the shape model, the analysis condition, and the optimization condition for plants A and B from the database 108. The information is entered at S100 and S200.

At S302, the optimization portion 104 determines a combination of design variables corresponding to the number of populations entered on the optimization input screen. The Latin hypercube sampling is used to determine a combination of 50 design variables for plant A and 50 design variables for plant B. Table 1 lists the combination of design variables determined by the Latin hypercube sampling for plant A.

TABLE 1

| | A | B | C | D | E | F |
|---|---|---|---|---|---|---|
| Population 1 | 1085.71 | 334.69 | 881.63 | 1202.04 | 1379.59 | 1032.65 |
| Population 2 | 971.43 | 200.00 | 1013.88 | 1276.51 | 1542.86 | 885.71 |
| Population 3 | 1191.84 | 297.96 | 969.80 | 1210.20 | 1493.88 | 1020.41 |
| Population 4 | 857.14 | 269.39 | 947.76 | 1283.67 | 1322.45 | 1026.53 |
| Population 5 | 1159.18 | 306.12 | 918.37 | 1271.43 | 1420.41 | 867.35 |
| Population 6 | 1118.37 | 281.63 | 720.00 | 1161.22 | 1591.84 | 800.00 |
| Population 7 | 889.80 | 367.35 | 1006.53 | 1259.18 | 1575.51 | 842.86 |
| Population 8 | 1126.53 | 314.29 | 999.18 | 1173.47 | 1395.92 | 855.10 |
| Population 9 | 1093.88 | 253.06 | 866.94 | 1263.27 | 1371.43 | 953.06 |
| Population 10 | 1053.06 | 224.49 | 844.90 | 1144.90 | 1412.24 | 1057.14 |
| Population 11 | 1110.20 | 216.33 | 742.04 | 1112.24 | 1559.18 | 812.25 |
| Population 12 | 832.65 | 391.84 | 800.82 | 1226.53 | 1469.39 | 879.59 |
| Population 13 | 955.10 | 363.27 | 859.59 | 1279.59 | 1453.06 | 959.18 |
| Population 14 | 881.63 | 326.53 | 991.84 | 1197.96 | 1510.20 | 910.20 |
| Population 15 | 800.00 | 285.71 | 888.98 | 1291.84 | 1567.35 | 1038.78 |
| Population 16 | 1061.22 | 302.04 | 1050.61 | 1218.37 | 1289.80 | 1093.88 |
| Population 17 | 1077.55 | 261.22 | 830.20 | 1234.69 | 1281.63 | 1014.29 |
| Population 18 | 808.16 | 355.10 | 984.49 | 1165.31 | 1257.14 | 1069.39 |
| Population 19 | 1200.00 | 387.76 | 815.51 | 1100.00 | 1551.02 | 1063.27 |
| Population 20 | 897.96 | 318.37 | 1065.31 | 1185.71 | 1534.69 | 897.96 |
| Population 21 | 1004.08 | 310.20 | 786.12 | 1136.73 | 1477.55 | 806.12 |
| Population 22 | 963.27 | 236.74 | 822.86 | 1206.12 | 1502.04 | 940.82 |
| Population 23 | 914.29 | 265.31 | 727.35 | 1238.78 | 1208.16 | 977.55 |
| Population 24 | 1134.69 | 338.78 | 852.25 | 1181.63 | 1428.57 | 1008.16 |
| Population 25 | 848.98 | 208.16 | 1035.92 | 1214.29 | 1518.37 | 934.69 |
| Population 26 | 1020.41 | 248.98 | 955.10 | 1287.76 | 1387.76 | 1002.04 |
| Population 27 | 816.33 | 277.55 | 734.69 | 1132.65 | 1297.96 | 824.49 |
| Population 28 | 922.45 | 351.02 | 903.67 | 1193.88 | 1346.94 | 989.80 |
| Population 29 | 1036.73 | 395.92 | 764.08 | 1128.57 | 1224.49 | 946.94 |
| Population 30 | 1012.24 | 257.14 | 749.39 | 1124.49 | 1526.53 | 995.92 |
| Population 31 | 840.82 | 204.08 | 793.47 | 1120.41 | 1273.47 | 1081.63 |
| Population 32 | 1028.57 | 400.00 | 1080.00 | 1267.35 | 1461.22 | 848.98 |
| Population 33 | 1142.86 | 342.86 | 911.02 | 1153.06 | 1265.31 | 830.61 |
| Population 34 | 946.94 | 244.90 | 756.74 | 1104.08 | 1444.90 | 1075.51 |
| Population 35 | 873.47 | 330.61 | 1043.27 | 1108.16 | 1485.71 | 891.84 |
| Population 36 | 1151.02 | 383.67 | 925.71 | 1140.82 | 1240.82 | 873.47 |
| Population 37 | 987.76 | 232.65 | 1021.22 | 1222.45 | 1248.98 | 836.74 |
| Population 38 | 865.31 | 228.57 | 1057.96 | 1295.92 | 1338.78 | 928.57 |
| Population 39 | 1183.67 | 375.51 | 896.33 | 1246.94 | 1330.61 | 1087.76 |
| Population 40 | 906.12 | 240.82 | 837.55 | 1300.00 | 1404.08 | 1044.90 |
| Population 41 | 1175.51 | 289.80 | 1028.57 | 1189.80 | 1583.67 | 861.22 |
| Population 42 | 1167.35 | 359.18 | 808.16 | 1169.39 | 1232.65 | 965.31 |
| Population 43 | 1069.39 | 322.45 | 977.14 | 1157.14 | 1600.00 | 983.67 |
| Population 44 | 1044.90 | 273.47 | 940.41 | 1177.55 | 1314.29 | 1051.02 |
| Population 45 | 930.61 | 371.43 | 933.06 | 1116.33 | 1216.33 | 904.08 |
| Population 46 | 938.78 | 220.41 | 962.45 | 1242.86 | 1355.10 | 1100.00 |
| Population 47 | 1102.04 | 379.59 | 771.43 | 1148.98 | 1363.27 | 971.43 |
| Population 48 | 979.59 | 212.25 | 778.78 | 1251.02 | 1200.00 | 818.37 |
| Population 49 | 824.49 | 293.88 | 1072.65 | 1255.10 | 1436.73 | 922.45 |
| Population 50 | 995.92 | 346.94 | 874.29 | 1230.61 | 1306.12 | 916.33 |

At S303, phase 2 generates an analysis model for the shape model acquired at S301 according to the combination of design variables determined at S302. In plant A concerning the shape model acquired at S301, phase 2 generates 50 shape models having dimension values corresponding to 50 populations determined by the Latin hypercube sampling as listed in Table 1. The analysis model generated for population 1 has dimension A set to 1085.71, dimension B set to 334.69, dimension C set to 881.63, dimension D set to 1202.04, dimension E set to 1379.59, and dimension F set to 1032.65. Populations 2 through 50 are similarly configured and analysis models are generated for 50 populations. Also in plant B, phase 2 generates 50 shape models having dimension values corresponding to 50 populations determined by the Latin hypercube sampling. At S303 in the embodiment, phase 2 generates 100 analysis models in total.

At S304, the analysis control portion 103 generates a mesh for an analysis domain of 100 analysis models generated at S303.

At S305, the analysis control portion 103 provides the analysis models generated at S304 with analysis conditions such as the entry boundary condition and the exit boundary condition entered on the analysis condition input screen at S100. The analysis control portion 103 provides 50 analysis models for plant A and 50 analysis models for plant B with the conditions entered on the analysis condition input screen for each of plants A and B.

At S306, the analysis control portion 103 performs fluid analysis on the analysis model generated at S305. The analysis control portion 103 performs parallel computation according to the number of CPUs equal to 5 entered on the optimization condition input screen at S200. The number of CPUs, i.e., 5 is entered for each of plants A and B. The analysis control portion 103 performs parallel computation by allocating five CPUs to the fluid analysis for plant A and allocating five CPUs to the fluid analysis for plant B. According to the embodiment, the fluid analysis is performed 100 times. The total of ten CPUs is used for the parallel computation.

At S307, the optimization portion 104 acquires the result of the fluid analysis performed at S306 and computes the objective function values entered on the optimization condition input screen at S100. The objective function values include the loss coefficient and the weight. The loss coefficient is computed according to equation 1 as follows.

Loss coefficient=(entry boundary pressure−exit boundary pressure)/entry boundary pressure Equation 1

The embodiment computes a pair of 50 loss coefficients and 50 weights for plants A and B.

At S308, phase 2 determines whether the value exceeds the number of generations entered on the optimization condition input screen at S200. Phase 2 proceeds to S310 if the value exceeds the number of generations. In this example, phase 2 determines whether the value exceeds 50 because the number of generations is set to 50. Phase 2 proceeds to S309 if the value does not exceed the number of generations.

At S309, phase 2 performs a convergence test. Phase 2 determines whether the value satisfies convergence test condition 1% entered on the optimization condition input screen at S200. The convergence test is available from equation 2 as follows.

$$ɛ = \frac{\vert yc - ye \vert}{ye} \qquad Equation 2$$

where yc denotes an optimal value for the objective function provided for the current population and ye denotes an optimal value for preceding objective functions. Phase 2 proceeds to S310 if the value satisfies the convergence test condition. Phase 2 proceeds to S302 if the value does not satisfy the convergence test condition. Phase 2 computes Pareto ranking in relation to the loss coefficient and the weight based on the multi-objective genetic algorithm. Phase 2 extracts populations with high Pareto ranking. Phase 2 applies crossover and mutation to the design variables to generate 50 new populations as new generation.

At S310, phase 2 supplies the database 108 with the computed design variable value and objective function value along with a computational log as an optimization result.

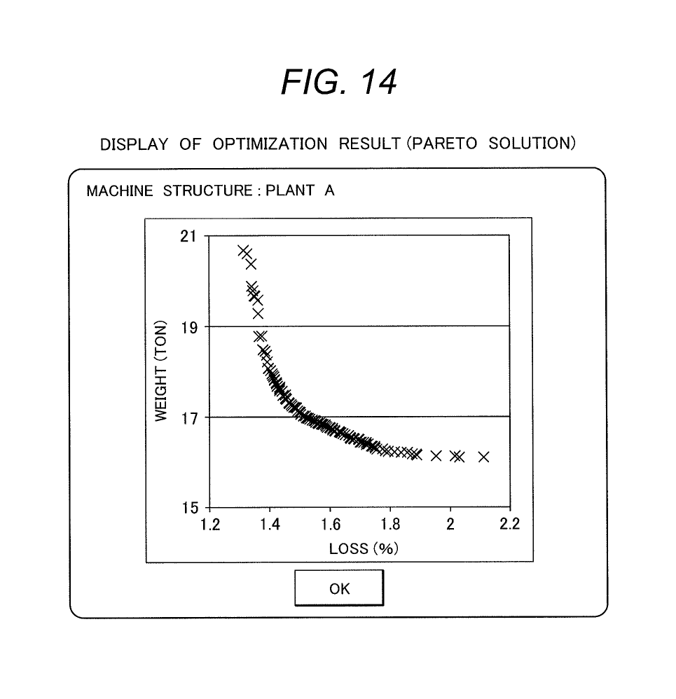

At S400, the computation result display portion 105 displays a computation result. FIG. 14 illustrates a screen displaying an optimization result (Pareto solution). FIG. 14 shows an optimization result for plant A. The optimization uses a multi-objective function including the loss coefficient and the weight as objective functions. The optimization result represents a trade-off curve referred to as a Pareto solution. In FIG. 14, the vertical axis represents the weight (TON) and the horizontal axis represents the loss (%). As seen from FIG. 14, decreasing the loss increases the weight. Decreasing the weight increases the loss. The Pareto solution represents the relation in which improving one objective function worsens the other objective function.

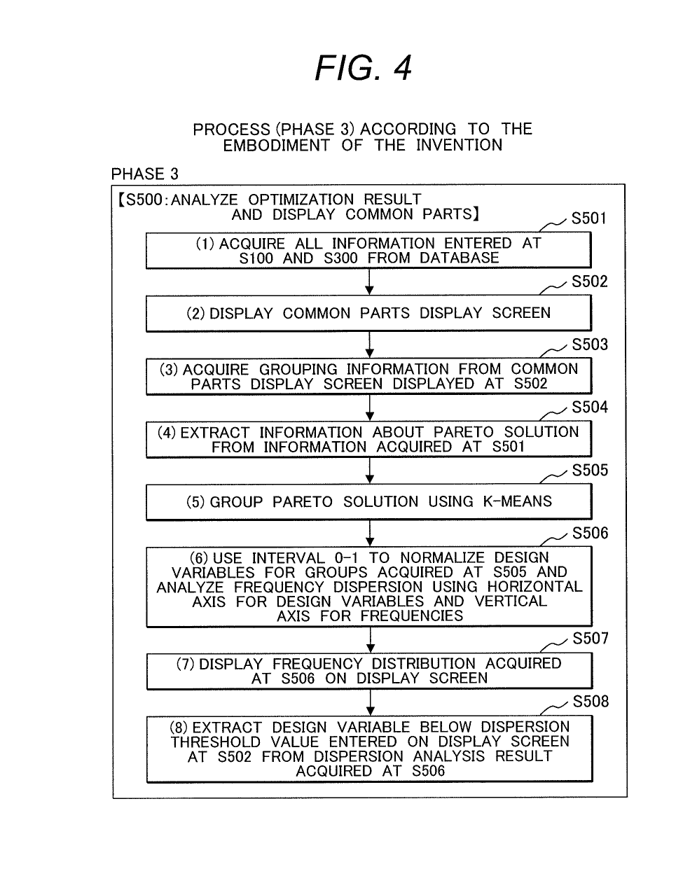

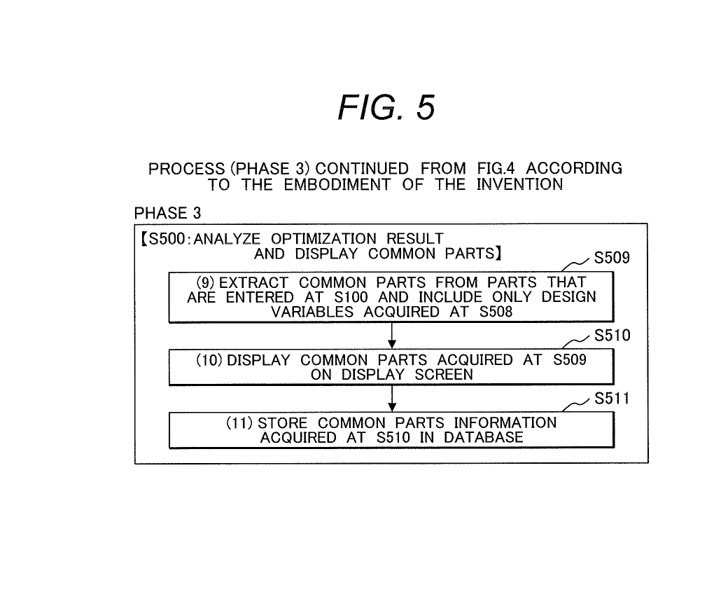

Phase 3 will be described. At S500 in FIGS. 4 and 5, the common parts evaluation portion 106 extracts common parts from the optimization result and the shape model information. The common parts display portion 107 displays the common parts.

At S501, the common parts evaluation portion 106 acquires information about the shape models and the optimization result for plants A and B from the database 108. The information is entered at S100 and S300.

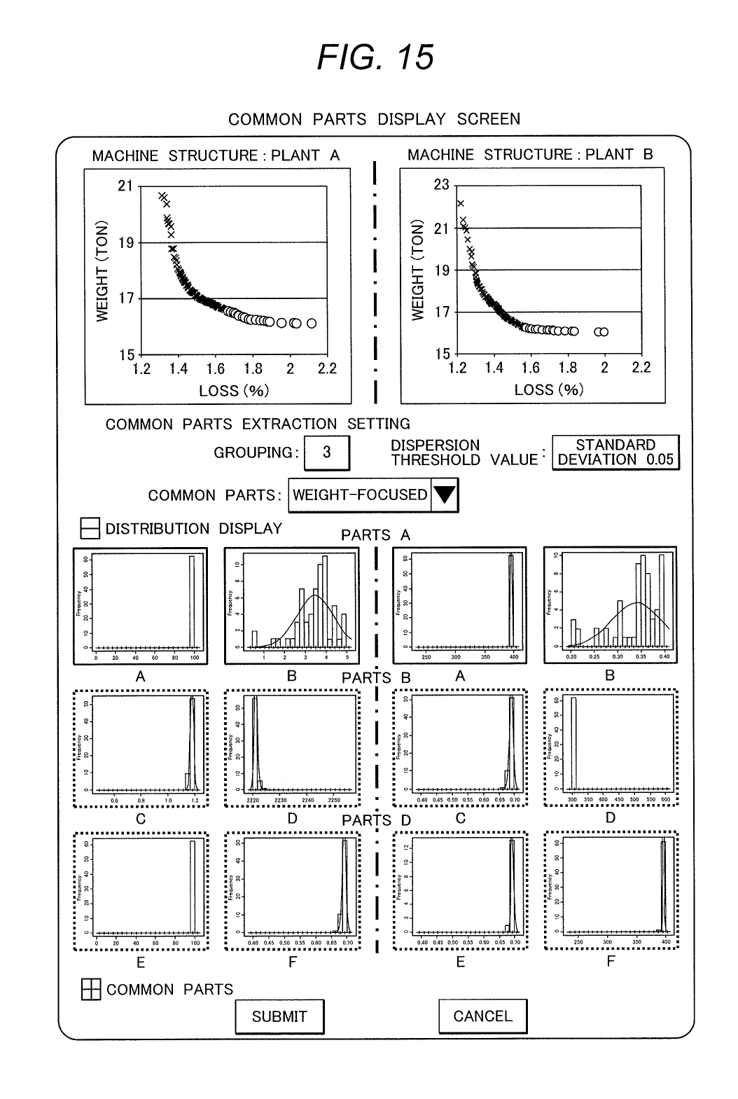

At S502, the common parts evaluation portion 106 displays the common parts display screen. FIG. 15 illustrates a common parts display screen. The common parts display screen displays Pareto solutions as the optimization results for plants A and B.

At S503, the common parts evaluation portion 106 acquires the grouping information entered on the common parts display screen. The common parts display screen in FIG. 15 shows 3 entered as the grouping.

At S504, the common parts evaluation portion 106 acquires the optimization result information acquired at S501, that is, the information about the design variable value for the Pareto solution, the loss coefficient, and the weight. According to the embodiment, the common parts evaluation portion 106 acquires two pieces of information about plants A and B.

At S505, the common parts evaluation portion 106 groups the Pareto solution into the number of groups acquired at S503. The example uses the K-means for grouping. The algorithm is shown below.

STEP 1: Randomly allocates data including the loss coefficient and the weight to three entered groups.

STEP 2: Computes the center of the groups, that is, an average of the groups based on the data allocated to the groups.

STEP 3: Finds a distance from the data including the loss coefficient and the weight to the center of the groups and re-allocates the data including the loss coefficient and the weight to a group most approximate to the center.

STEP 4: Repeats STEP 2 and STEP 3 until the allocation is unchanged. The embodiment uses the K-means to classify the Pareto solutions for plants A and B each into three groups. FIG. 15 illustrates the Pareto solution classified into three groups. In FIG. 15, the symbol X denotes a performance-focused group, the symbol ◯ denotes a weight-focused group, and the black triangle denotes a balance group in consideration of the performance and the weight.

At S506, the common parts evaluation portion 106 uses interval 0-1 to normalize design variables for the groups of the Pareto solution acquired at S505. The common parts evaluation portion 106 finds the frequency distribution using the horizontal axis for design variables and the vertical axis for frequencies and computes the dispersion of each frequency distribution. The embodiment finds the frequency distribution and the dispersion of six design variables for plants A and B.

At S507, the common parts evaluation portion 106 displays the frequency distribution acquired at S506 on the common parts display screen. FIG. 15 illustrates a common parts display screen. The common parts display screen contains “common parts:” for weight-focused groups. The example is configured to extract common parts for weight-focused groups. The Pareto solution in FIG. 15 corresponds to the groups on the left. Under the distribution display, the common parts display screen contains the distribution using the horizontal axis for design variables and the vertical axis for frequencies.

At S508, the common parts evaluation portion 106 acquires the dispersion of each design variable computed at S506. The common parts evaluation portion 106 extracts design variables below a dispersion threshold value entered on the common parts display screen. The common parts display screen is supplied with standard deviation 0.05 as the dispersion threshold value. That is, common parts are assumed to allow a variation within approximately ±5% of the average. The common parts evaluation portion 106 extracts design variables whose standard deviation equals to 0.05. According to the embodiment, design variables C and D for part B and design variables E and F for part D are smaller than the threshold value. In FIG. 15, the design variables corresponding to the distributions enclosed in broken lines are smaller than the threshold value.

At S509 in FIG. 5, the common parts evaluation portion 106 extracts common parts equal to parts related to only the design variables for plants A and B that are extracted at S508 and are smaller than the threshold value. In the example, parts B and D indicate all the design variables smaller than the threshold value throughout plants A and B and are therefore assumed to be common parts. The Pareto solution provides a design variable that causes little variation or dispersion even if specifications are changed. The dimension of such a design variable need not be changed. The design variable is assumed to be unchanged. A part having unchanged design variables need not change its shape and is therefore assumed to be common parts.

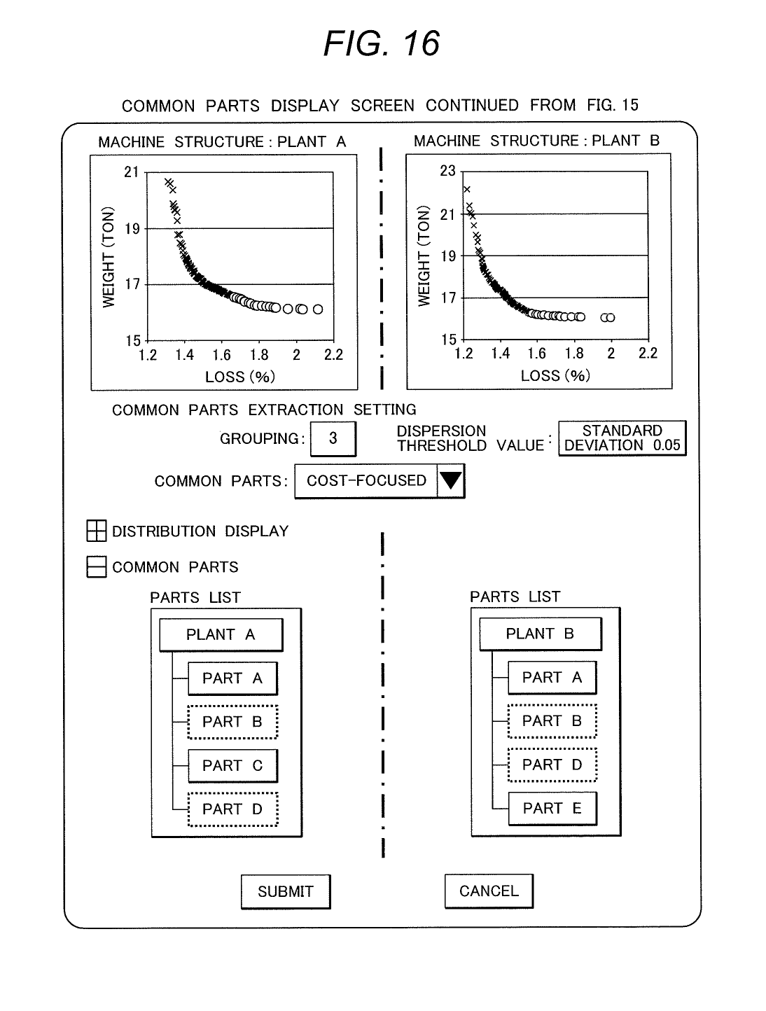

At S510, the common parts evaluation portion 106 displays the parts extracted at S509 on the common parts display screen. FIG. 16 illustrates a common parts display screen. In FIG. 16, the parts list contains common parts highlighted with broken lines. At S511, the common parts evaluation portion 106 stores the common parts information acquired at S510 in the database.

As described above, the multi-objective optimization is performed to analyze the distribution of the Pareto solution as an acquired optimization result. Parts corresponding to design variables with little dispersion are assumed to be common parts. The parts can be used in common.

According to the description of the invention, the information about plants A and B is entered at the same location. The information can be entered at different locations using the network environment.

The specification discloses an apparatus and a method to acquire common parts using multi-objective optimization, specifically, a design support system using common parts and a method thereof, including the following means. One means enters information about a shape model, an analysis condition, and an optimization condition. Another means performs multi-objective optimization. Still another means groups a Pareto solution as an acquired optimization result, analyzes dispersion of design variables, and associates them with a shape model. Yet another means displays common parts.

The specification discloses an apparatus and a method to acquire common parts using multi-objective optimization, specifically, a design support system using common parts and a method thereof, including the following means. One means enters information about a shape model, an analysis condition, and an optimization condition. Another means uses the genetic algorithm to perform multi-objective optimization. Still another means groups a Pareto solution as an acquired optimization result, analyzes dispersion of design variables, and associates them with a shape model. Yet another means displays common parts.

The specification discloses an apparatus and a method to acquire common parts using multi-objective optimization, specifically, a design support system using common parts and a method thereof, including the following means. One means enters information about a shape model, an analysis condition, and an optimization condition. Another means uses the genetic algorithm to perform multi-objective optimization. Still another means groups a Pareto solution as an acquired optimization result using K-means, analyzes dispersion of design variables, and associates them with a shape model. Yet another means displays common parts.

The invention is not limited to the above-mentioned embodiments and may include various modifications. For example, the above-mentioned embodiments have been described in detail in order to easily understand the invention and do not necessarily have all the configurations that have been described. The configuration of one embodiment can be partly replaced by the configuration of another embodiment. The configuration of one embodiment can be additionally supplied with the configuration of another embodiment. Configurations of the embodiments can be partly supplemented from the other embodiments, deleted, or replaced by the other configurations.

Hardware such as integrated circuits may replace all or part of the above-mentioned configurations, functions, process portions, and process means. Software may replace the above-mentioned configurations and functions so that the processor interprets and performs programs that implement the functions. Information such as the programs, tables, and files needed to implement the functions can be stored in recording devices such as memory, hard disk, and solid state drive (SSD) or recording media such as an IC card, SD, card, and DVD.

The illustrated control lines or information lines are considered necessary for the description. All control lines or information lines needed for products are not shown. Actually, almost all the configurations may be connected to each other.

1. A design support system to acquire common parts, comprising:
an input portion that accepts information about a shape model to extract common parts, an analysis condition, and an optimization condition;
an optimization portion that references the information and performs multi-objective optimization;
an evaluation portion that groups a Pareto solution as an acquired optimization result, analyzes dispersion of design variables, associates design variables with a shape model, and extracts specifically associated parts as common parts; and
a display portion that displays extracted common parts.

2. The design support system according to claim 1,
wherein genetic algorithm is used and performed as the multi-objective optimization.

3. The design support system according to claim 1,
wherein K-means is used to group the Pareto solution.

4. A design support system having a network, a computer connected to the network, and a terminal connected to the network, the design support system comprising:
an input portion that accepts information about a shape model to extract common parts, an analysis condition, and an optimization condition from the terminal;
an optimization portion that references the information and performs multi-objective optimization;
an evaluation portion that groups a Pareto solution as an acquired optimization result, analyzes dispersion of design variables, associates design variables with a shape model, and extracts specifically associated parts as common parts; and
a display portion that displays extracted common parts.

5. The design support system according to claim 4,
wherein genetic algorithm is used and performed as the multi-objective optimization.

6. The design support system according to claim 4,
wherein K-means is used to group the Pareto solution.

7. A design support method to acquire common parts, comprising:
accepting information about a shape model to extract common parts, an analysis condition, and an optimization condition from a user terminal;
referencing the information and performing multi-objective optimization;
grouping a Pareto solution as an acquired optimization result;
analyzing dispersion of design variables;
associating design variables with a shape model;
extracting specifically associated parts as common parts; and
displaying the common parts on the user terminal.

8. The design support method according to claim 7,
wherein genetic algorithm is used and performed as the multi-objective optimization.

9. The design support method according to claim 7,
wherein K-means is used to group the Pareto solution.
